(19) United States
(12) Patent Application Publication
(10) Pub. No.: US 2026/0235907 A1
(43) Pub. Date: Aug. 13, 2026

(54) BACKLIGHT MODULE AND DISPLAY DEVICE

(71) Applicant: Coretronic Corporation, Hsin-Chu (TW)

(72) Inventors: Shih-Yen Cheng, Hsin-Chu (TW); Chun-Wei Lee, Hsin-Chu (TW)

(73) Assignee: Coretronic Corporation, Hsin-Chu (TW)

(21) Appl. No.: 19/458,948

(22) Filed: Jan. 26, 2026

(30) Foreign Application Priority Data
Feb. 13, 2025 (TW) 114201472

(51) Int. Cl. G02F 1/1335; F21V 8/00; G02B 3/08

(52) U.S. Cl. CPC G02F 1/133607; G02B 3/08; G02B 6/0036

(57) ABSTRACT

A backlight module including a circuit board, a plurality of light-emitting elements, an anisotropic diffusion sheet, a plurality of Fresnel lenses, and an optical brightness enhancement film is provided. The plurality of light-emitting elements are disposed on the circuit board. The anisotropic diffusion sheet is disposed on one side of a light-emitting surface of each of the light-emitting elements. The plurality of Fresnel lenses are disposed between the plurality of light-emitting elements and the anisotropic diffusion sheet, and are arranged to overlap the plurality of light-emitting elements. The optical brightness enhancement film is disposed on one side of the anisotropic diffusion sheet facing away from the plurality of Fresnel lenses. A display device adopting the backlight module is also provided.

### CROSS-REFERENCE TO RELATED APPLICATION

This application claims the priority benefit of Taiwan application serial no. 114201472, filed on Feb. 13, 2025. The entirety of the above-mentioned patent application is hereby incorporated by reference herein and made a part of this specification.

### BACKGROUND

### Technical Field

The disclosure relates to an optical module and an electronic device, and more particularly to a backlight module and a display device.

### Description of related Art

With the advancement of display technologies, the applications of in-vehicle displays have become increasingly diverse. A head-up display (HUD), which projects images onto a vehicle’s windshield, is one such application. Generally, for driving safety considerations, automotive windshields have low reflectance, such as 20%. Therefore, the luminance of the HUD must be significantly increased to meet the required display brightness, which results in increased power consumption and heat generation. On the other hand, to prevent the human eye from directly viewing the display screen of the HUD, thereby affecting the projected image quality, the display surface of the HUD is typically arranged approximately parallel to the viewer’s line of sight or facing away from the viewer. However, most HUDs currently use backlight sources that emit light concentrated in a direction perpendicular to the display surface, which limits the efficiency of light utilization.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a backlight module and a display device with improved light energy utilization efficiency.

Other objects and advantages of the disclosure may be further understood from the technical features disclosed herein.

To achieve one, part, or all of the above-mentioned objects, or other objects, an embodiment of the disclosure provides a backlight module. The backlight module includes a circuit board, a plurality of light-emitting elements, an anisotropic diffusion sheet, a plurality of Fresnel lenses, and an optical brightness enhancement film. The plurality of light-emitting elements are disposed on the circuit board. The anisotropic diffusion sheet is disposed on one side of a light-emitting surface of each of the light-emitting elements. The plurality of Fresnel lenses are disposed between the plurality of light-emitting elements and the anisotropic diffusion sheet, and are arranged to overlap the plurality of light-emitting elements. The optical brightness enhancement film is disposed on one side of the anisotropic diffusion sheet facing away from the plurality of Fresnel lenses.

To achieve one, part, or all of the above-mentioned objects, or other objects, an embodiment of the disclosure provides a display device. The display device includes a backlight module and a display panel. The backlight module includes a circuit board, a plurality of light-emitting elements, an anisotropic diffusion sheet, a plurality of Fresnel lenses, and an optical brightness enhancement film. The plurality of light-emitting elements are disposed on the circuit board. The anisotropic diffusion sheet is disposed on one side of a light-emitting surface of each of the light-emitting elements. The plurality of Fresnel lenses are disposed between the plurality of light-emitting elements and the anisotropic diffusion sheet, and are arranged to overlap the plurality of light-emitting elements. The optical brightness enhancement film is disposed on one side of the anisotropic diffusion sheet facing away from the plurality of Fresnel lenses. The display panel is disposed on one side of the optical brightness enhancement film facing away from the plurality of light-emitting elements.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display device according to a first embodiment of the disclosure.

FIG. 2A is a schematic top view of the Fresnel lens of FIG. 1.

FIG. 2B is a schematic top view of another embodiment of the Fresnel lens of FIG. 1.

FIG. 3 is a schematic diagram illustrating the light diffusion effect of the anisotropic diffusion sheet of FIG. 1.

FIG. 4 is a schematic cross-sectional view of a display device according to a second embodiment of the disclosure.

FIG. 5A is a schematic perspective view of the freeform surface lens of FIG. 4.

FIG. 5B is a schematic perspective view of another embodiment of the freeform surface lens of FIG. 4.

FIG. 6 is a diagram illustrating the light output distribution of the backlight module of FIG. 4.

FIG. 7 is a diagram illustrating the light output distribution of a backlight module of a comparative example.

FIG. 8 is a schematic cross-sectional view of a display device of a comparative example.

FIG. 9 is a schematic cross-sectional view of a display device according to a third embodiment of the disclosure.

FIG. 10 is a schematic enlarged view of the optical brightness enhancement film of FIG. 9.

FIG. 11 is a distribution diagram illustrating the normalized luminance versus viewing angle of the display device of FIG. 9.

FIG. 12 is a diagram illustrating the light output distribution of the backlight module of FIG. 9.

FIG. 13 is a schematic diagram illustrating the configuration of the display device of FIG. 9 when used as a head-up display.

FIG. 14 is a schematic cross-sectional view of a display device according to a fourth embodiment of the disclosure.

FIG. 15 is a schematic cross-sectional view of a display device according to a fifth embodiment of the disclosure.

FIG. 16 is a schematic cross-sectional view of a display device according to a sixth embodiment of the disclosure.

FIG. 17 is a schematic cross-sectional view of a display device according to a seventh embodiment of the disclosure.

FIG. 18 is a diagram illustrating the light output distribution of the backlight module of FIG. 17.

FIG. 19 is a schematic cross-sectional view of a display device according to an eighth embodiment of the disclosure.

FIGS. 20A and 20B are schematic cross-sectional views of a display device according to a ninth embodiment of the disclosure, operated in a privacy mode and a sharing mode, respectively.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

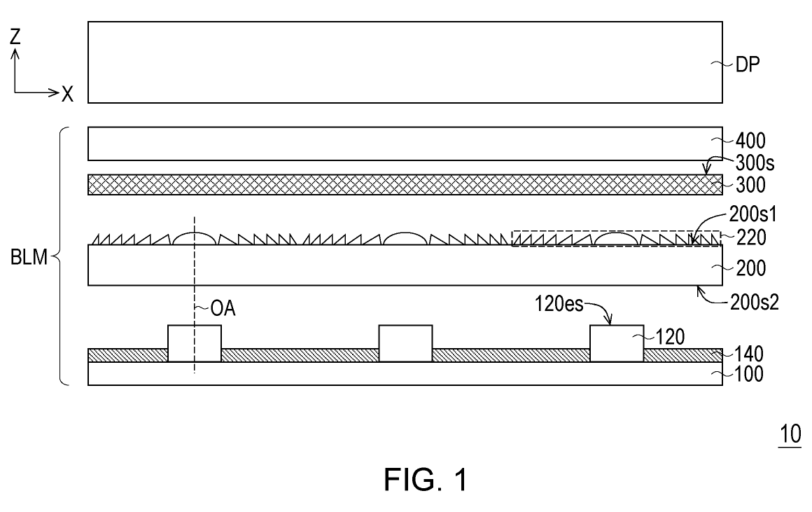

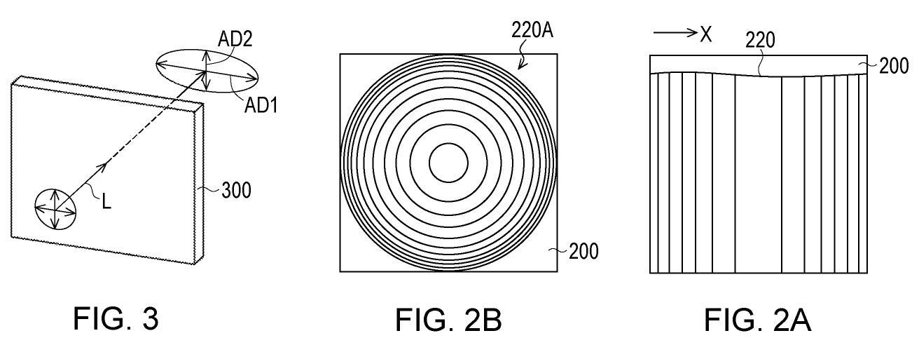

FIG. 1 is a schematic cross-sectional view of a display device according to a first embodiment of the disclosure. FIG. 2A is a schematic top view of the Fresnel lens of FIG. 1. FIG. 2B is a schematic top view of another embodiment of the Fresnel lens of FIG. 1. FIG. 3 is a schematic diagram illustrating the light diffusion effect of the anisotropic diffusion sheet of FIG. 1.

Referring to FIG. 1, a display device 10 includes a backlight module BLM and a display panel DP. The backlight module BLM includes a circuit board 100 and a plurality of light-emitting elements 120. These light-emitting elements 120 are disposed on the circuit board 100 and are electrically connected to the circuit board 100. For example, the plurality of light-emitting elements 120 may be arranged in an array on the circuit board 100, and the circuit board 100 is adapted to individually control the light emission of these light-emitting elements 120. In other words, the backlight module BLM of the embodiment may have a local dimming function, but the disclosure is not limited thereto. In the embodiment, the light-emitting elements 120 may be, for example, mini light-emitting diodes (mini-LEDs), but the disclosure is not limited thereto. In other embodiments, the light-emitting elements 120 may be micro light-emitting diodes (micro-LEDs).

Each of the light-emitting elements 120 has a light-emitting surface 120es facing away from the circuit board 100. The backlight module BLM is further provided with a plurality of Fresnel lenses 220, an anisotropic diffusion sheet 300, and an optical brightness enhancement film 400 on one side of the light-emitting surface 120es of each of the plurality of light-emitting elements 120. The plurality of Fresnel lenses 220 are disposed between the plurality of light-emitting elements 120 and the anisotropic diffusion sheet 300. The optical brightness enhancement film 400 is disposed on one side of the anisotropic diffusion sheet 300 facing away from these Fresnel lenses 220. The display panel DP is disposed on one side of the optical brightness enhancement film 400 facing away from these light-emitting elements 120. However, in other embodiments, the light-emitting surface of the light-emitting element is not limited to the surface facing away from the circuit board and may be a side surface of the light-emitting element, or both the surface facing away from the circuit board and the side surface may serve as light-emitting surfaces.

In the embodiment, the backlight module BLM may further include a light guide plate 200. The light guide plate 200 is disposed between the plurality of light-emitting elements 120 and the anisotropic diffusion sheet 300, and the plurality of Fresnel lenses 220 are disposed on a first surface 200s1 of the light guide plate 200 facing away from the circuit board 100. However, the disclosure is not limited thereto. In other embodiments, the Fresnel lenses 220 may be disposed on a second surface 200s2 of the light guide plate 200 facing the circuit board 100, or may be simultaneously disposed on both the first surface 200s1 and the second surface 200s2 of the light guide plate 200, wherein the first surface 200s1 and the second surface 200s2 face away from each other. For example, in the embodiment, the Fresnel lens 220 may be formed by a plurality of strip-shaped prisms arranged along a direction (e.g., direction X) parallel to the first surface 200s1 (as shown in FIG. 2A), that is, the Fresnel lens 220 of the embodiment is a one-dimensional lens structure. However, the disclosure is not limited thereto. In another embodiment, the Fresnel lens 220A may be formed by a plurality of annular prisms arranged concentrically (as shown in FIG. 2B), that is, the Fresnel lens 220A is a two-dimensional lens structure.

It is particularly noted that, in the embodiment, each of the plurality of Fresnel lenses 220 has an optical axis OA, and a plurality of optical axes OA of these Fresnel lenses 220 respectively pass through the plurality of light-emitting elements 120. In other words, the Fresnel lenses 220 are respectively disposed corresponding to the plurality of light-emitting elements 120, that is, these Fresnel lenses 220 are disposed overlapping the plurality of light-emitting elements 120. The Fresnel lens 220 is configured to convert the light emitted from the light-emitting element 120 into near-collimated light.

The anisotropic diffusion sheet 300 has different diffusion capabilities in different dimensions parallel to a film surface 300s thereof. For example, in the embodiment, the anisotropic diffusion sheet 300 is adapted to expand the light distribution pattern of light L along a specific direction (e.g., axial direction AD1) and to maintain the light distribution pattern of light L in a direction perpendicular to the specific direction (e.g., axial direction AD2), as shown in FIG. 3. Therefore, the configuration of the anisotropic diffusion sheet 300 not only improves the visual quality of the backlight module BLM, but also satisfies different light distribution pattern requirements, thereby improving the light energy utilization efficiency of the backlight module BLM.

On the other hand, in the embodiment, the optical brightness enhancement film 400 may be, for example, a reflective polarizing brightness enhancement film (Dual Brightness Enhancement Film, DBEF), which is adapted to allow the transmitted light to have a single polarization state, thereby increasing the transmittance of the light emitted from the backlight module BLM through the display panel DP. However, the disclosure is not limited thereto. In other embodiments, the optical brightness enhancement film 400 may be two prism films whose prism extending directions are orthogonal to each other.

In the embodiment, to enhance the light-emitting efficiency of the light-emitting elements 120, the backlight module BLM may further include a reflective sheet 140 disposed on the circuit board 100 and not overlapping the light-emitting elements 120. From another perspective, the reflective sheet 140 is located between the plurality of light-emitting elements 120 and exposes these light-emitting elements 120. The reflective sheet 140 is adapted to reflect light emitted from the light-emitting elements 120 toward the circuit board 100 back toward the display panel DP.

Several other embodiments are described below in detail to further illustrate the disclosure. Identical elements are denoted by the same reference numerals, and descriptions of identical technical content are omitted. Please refer to the foregoing embodiment for the omitted parts, which will not be repeated here.

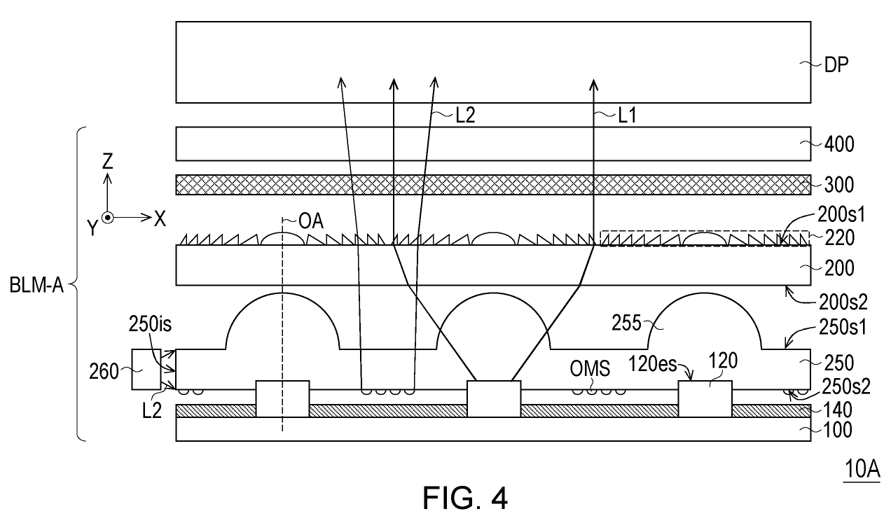

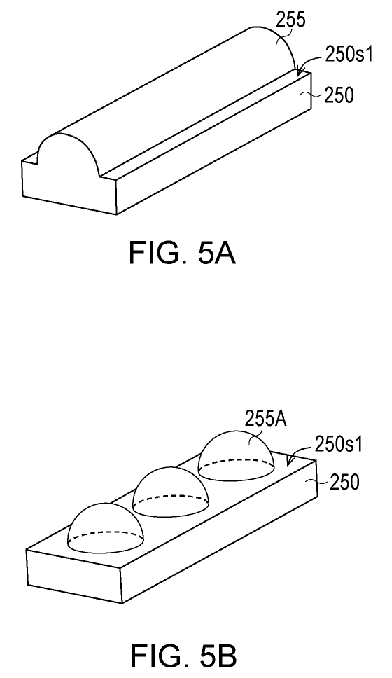

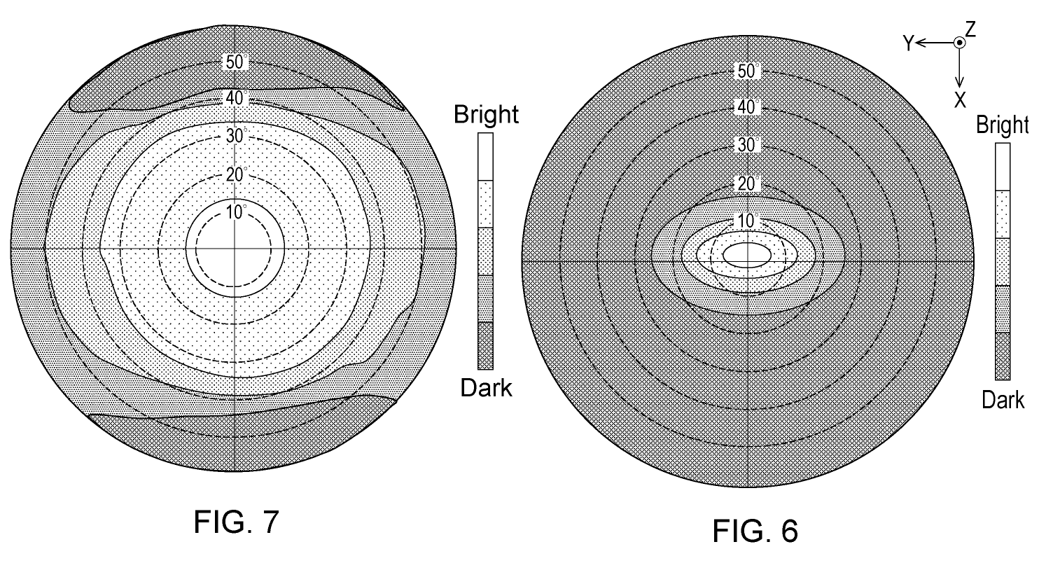

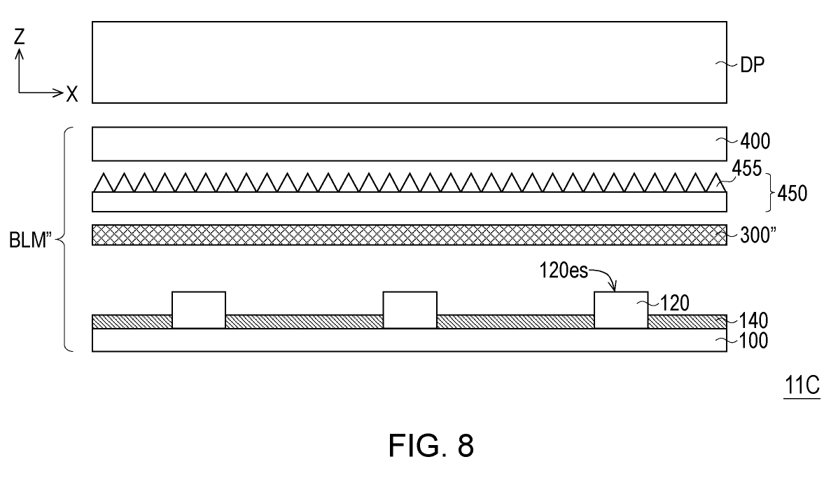

FIG. 4 is a schematic cross-sectional view of a display device according to a second embodiment of the disclosure. FIG. 5A is a schematic perspective view of the freeform surface lens of FIG. 4. FIG. 5B is a schematic perspective view of another embodiment of the freeform surface lens of FIG. 4. FIG. 6 is a diagram illustrating the light output distribution of the backlight module of FIG. 4. FIG. 7 is a diagram illustrating the light output distribution of a backlight module of a comparative example. FIG. 8 is a schematic cross-sectional view of a display device of a comparative example.

Referring to FIG. 4, compared to the display device 10 in FIG. 1, a backlight module BLM-A of a display device 10A of the embodiment may further include a light guide plate 250 and a plurality of freeform surface lenses 255. The light guide plate 250 is disposed between the plurality of light-emitting elements 120 and the plurality of Fresnel lenses 220, and covers a plurality of light-emitting surfaces 120es of the light-emitting elements 120. These freeform surface lenses 255 are disposed on the first surface 250s1 of the light guide plate 250 facing away from the circuit board 100 and respectively overlap the light-emitting elements 120 along a normal direction (e.g., direction Z) of the first surface 250s1. In other words, the plurality of freeform surface lenses 255 are respectively arranged corresponding to the plurality of light-emitting elements 120.

The freeform surface lens 255 is configured to concentrate light L1 emitted from the light-emitting element 120 in the normal direction (e.g., direction Z) of the first surface 250s1. The Fresnel lens 220 is configured to convert the light L1 from the freeform surface lenses 255 into near-collimated light. For example, in the embodiment, the freeform surface lens 255 may be a one-dimensional lens structure, such as a cylindrical lens as shown in FIG. 5A. However, the disclosure is not limited thereto. In other embodiments, the freeform surface lens 255A may be a two-dimensional lens structure, as shown in FIG. 5B. In the embodiment, the light-emitting elements 120 may be embedded in the light guide plate 250. More specifically, referring to the surface of the circuit board 100 on which the light-emitting elements 120 are disposed as a reference plane, the height of the light-emitting surface 120es of the light-emitting element 120 is greater than the height of the second surface 250s2 of the light guide plate 250 facing the circuit board 100, but the disclosure is not limited thereto. In other embodiments, the light-emitting elements 120 may not be embedded in the light guide plate 250. More specifically, referring to the surface of the circuit board 100 on which the light-emitting elements 120 are disposed as a reference plane, the height of the light-emitting surface 120es may be lower than or equal to the height of the second surface 250s2 of the light guide plate 250 facing the circuit board 100.

Furthermore, the backlight module BLM-A may further include an auxiliary light-emitting element 260 and a plurality of optical microstructures OMS. The auxiliary light-emitting element 260 is disposed on one side of a light-incident surface 250is of the light guide plate 250, wherein the light-incident surface 250is connects the first surface 250s1 and the second surface 250s2. The plurality of optical microstructures OMS are disposed on the second surface 250s2 of the light guide plate 250. For example, in the embodiment, the optical microstructures OMS may be protrusions protruding outward from the second surface 250s2 of the light guide plate 250, but the disclosure is not limited thereto. In other embodiments, the optical microstructures may be recesses recessed inward from the second surface 250s2 of the light guide plate 250.

It is particularly noted that the plurality of optical microstructures OMS are located between the plurality of light-emitting elements 120. More specifically, in the normal direction (e.g., direction Z) of the second surface 250s2 of the light guide plate 250, these optical microstructures OMS do not overlap the plurality of freeform surface lenses 255, that is, these optical microstructures OMS are arranged without overlapping the plurality of freeform surface lenses 255. In the embodiment, the light L2 emitted from the auxiliary light-emitting element 260 is adapted to propagate within the light guide plate 250 and is reflected by the plurality of optical microstructures OMS toward the spaces between the plurality of freeform surface lenses 255. Accordingly, the light output of the backlight module BLM-A in the dark areas between the plurality of light-emitting elements 120 can be increased, thereby reducing the impact of the dark areas on display quality.

FIG. 8 illustrates a display device 11C of a comparative example. Referring to FIGS. 4 and 8, a backlight module BLM” of the comparative example does not include the light guide plate 250, the plurality of freeform surface lenses 255, the auxiliary light-emitting element 260, and the plurality of Fresnel lenses 220 of the backlight module BLM-A of the embodiment. In the backlight module BLM” of the comparative example, the diffusion sheet 300” has the same light diffusion capability in any direction parallel to the film surface, that is, the diffusion capability of the diffusion sheet 300” of the comparative example is not anisotropic. On the other hand, a prism sheet 450 is further disposed between the diffusion sheet 300” and the optical brightness enhancement film 400 in the backlight module BLM” of the comparative example, wherein the prism sheet 450 has a plurality of prism structures 455, and these prism structures 455 are arranged along the direction X.

As shown in FIGS. 6 and 7, compared with the backlight module BLM” of the comparative example, the backlight module BLM-A of the embodiment exhibits significantly better light-concentrating capability. In addition, the front-view luminance of the backlight module BLM-A of the embodiment can reach 4.2 times that of the backlight module BLM” of the comparative example.

Referring to FIGS. 4 and 6, in the embodiment, the anisotropic diffusion sheet 300 is adapted to expand the light distribution pattern of the light along the direction Y while maintaining the light distribution pattern along the direction X. That is, the axial direction AD1 and the axial direction AD2 in FIG. 3 are parallel to the directions Y and X in FIG. 4, respectively.

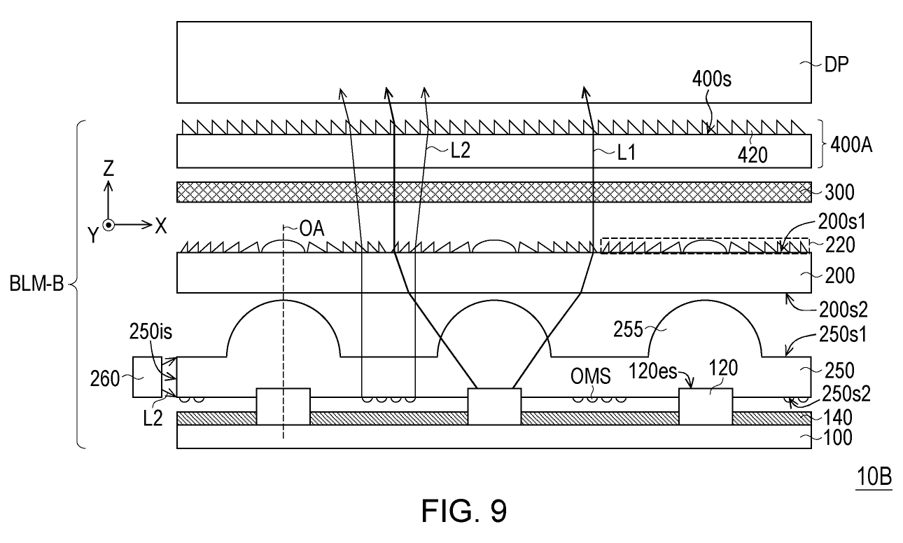

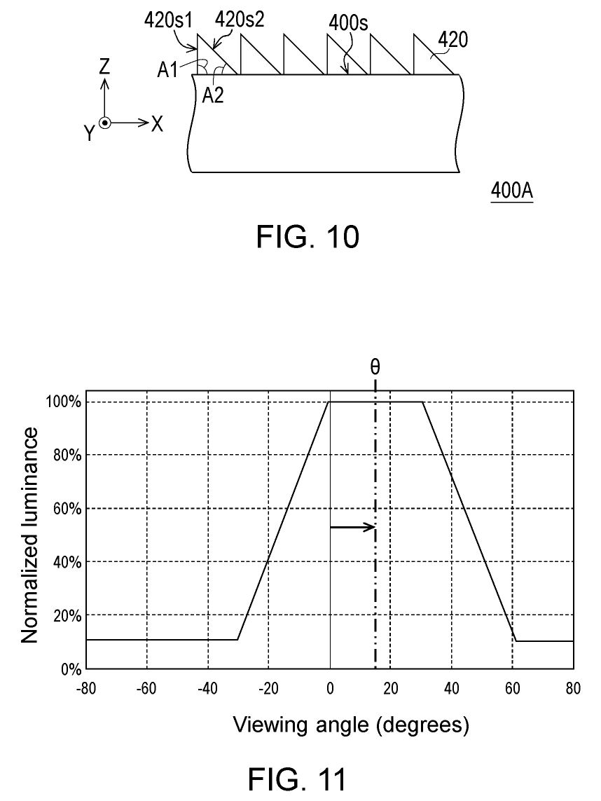

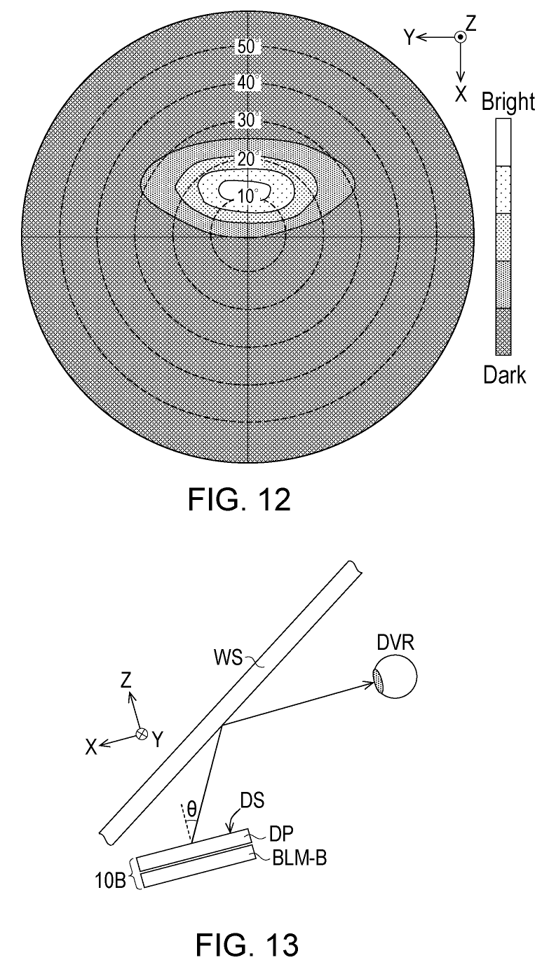

FIG. 9 is a schematic cross-sectional view of a display device according to a third embodiment of the disclosure. FIG. 10 is a schematic enlarged view of the optical brightness enhancement film of FIG. 9. FIG. 11 is a distribution diagram illustrating the normalized luminance versus viewing angle of the display device of FIG. 9. FIG. 12 is a diagram illustrating the light output distribution of the backlight module of FIG. 9. FIG. 13 is a schematic diagram illustrating the configuration of the display device of FIG. 9 when used as a head-up display.

Referring to FIGS. 9 and 10, compared with the display device 10A shown in FIG. 4, a backlight module BLM-B of a display device 10B of the embodiment further includes a plurality of prism structures 420 on a film surface 400s of the optical brightness enhancement film 400A facing away from the plurality of light-emitting elements 120. In the embodiment, the prism structures 420 may be arranged along the X direction and extend in the Y direction. Each of the prism structures 420 includes a first optical surface 420s1 and a second optical surface 420s2 connected to each other. A first base angle A1 between the first optical surface 420s1 and the film surface 400s is greater than a second base angle A2 between the second optical surface 420s2 and the film surface 400s.

The plurality of first optical surfaces 420s1 and the plurality of second optical surfaces 420s2 of the plurality of prism structures 420 are alternately arranged along a direction (e.g., the X direction) parallel to the film surface 400s. From another perspective, the plurality of first optical surfaces 420s1 of the prism structures 420 all face one side of the optical brightness enhancement film 400A, and the plurality of second optical surfaces 420s2 all face the opposite side of the optical brightness enhancement film 400A.

The arrangement of the prism structures 420 allows the light passing through the optical brightness enhancement film 400A to deviate from the normal direction of the film surface 400s and be guided to a specific viewing angle. For example, the peak of the light distribution pattern of the backlight module BLM-B of the embodiment can be shifted to a viewing angle θ by the arrangement of the prism structures 420, wherein θ is, for example, in a range of 10 degrees to 20 degrees (as shown in FIG. 11). As shown in FIGS. 6 and 12, the light distribution of the backlight module BLM-B of the embodiment is shifted in the vertical direction by at least 10 degrees compared with that of the backlight module BLM-A of FIG. 4.

Based on the aforementioned light-emitting characteristics, the display device 10B of the embodiment can be used as an automotive head-up display, as shown in FIG. 13. The display image of the display device 10B can be projected onto a windshield WS of a vehicle for viewing by a driver DVR. Since the light distribution of the backlight module BLM-B of the embodiment is directed to a specific angle (i.e., the viewing angle θ) away from the front-view direction, the display surface DS of the display device 10B does not need to be positioned directly facing the projection path. For example, the normal direction of the display surface DS may deviate from the projection path by at least 10 degrees (or alternatively, direct the projection path toward the viewing angle θ of the display device 10B). As a result, the display surface DS of the display device 10B can be oriented toward the windshield WS as much as possible to reduce or avoid the display image being directly visible to the driver DVR, thereby enhancing driving safety. Meanwhile, the light distribution deviating from the front-view direction allows the display efficiency of the display device 10B to be maximized when used as a head-up display.

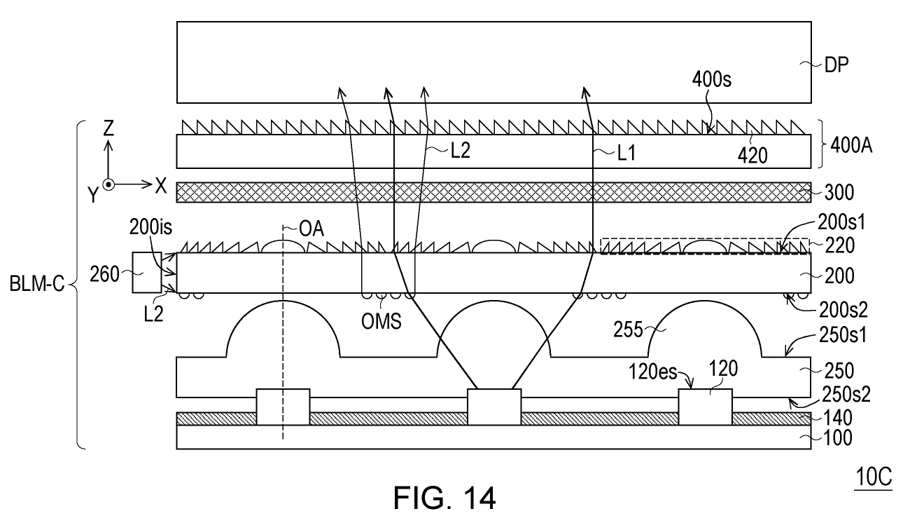

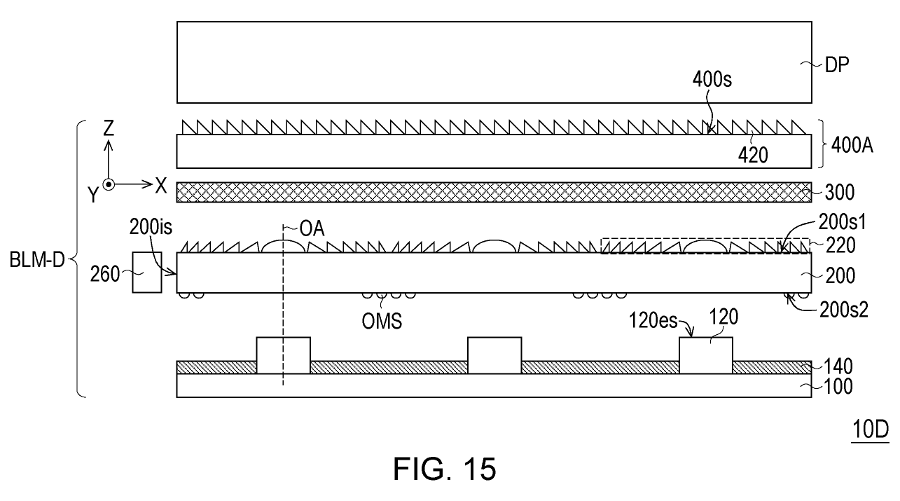

FIG. 14 is a schematic cross-sectional view of a display device according to a fourth embodiment of the disclosure. FIG. 15 is a schematic cross-sectional view of a display device according to a fifth embodiment of the disclosure. Referring to FIG. 14, the difference between a display device 10C of the embodiment and the display device 10B of FIG. 9 lies in the configuration of the auxiliary light-emitting element and the optical microstructures.

Specifically, in the embodiment, the auxiliary light-emitting element 260 of the backlight module BLM-C is disposed on one side of a light-incident surface 200is of the light guide plate 200, and the plurality of optical microstructures OMS are disposed on the second surface 200s2 of the light guide plate 200 facing the circuit board 100 and located between the plurality of light-emitting elements 120. The first surface 200s1 and the second surface 200s2 are connected to the light-incident surface 200is. It should be noted that the plurality of optical axes OA of the plurality of Fresnel lenses 220 disposed on the first surface 200s1 of the light guide plate 200 do not pass through the optical microstructures OMS.

Since the auxiliary light-emitting element 260 and the plurality of optical microstructures OMS in the embodiment provide technical effects to the backlight module BLM-C similar to those provided by the auxiliary light-emitting element 260 and the optical microstructures OMS of the backlight module BLM-B of FIG. 9, detailed descriptions can be found in the related paragraphs of the aforementioned embodiment and will not be repeated here.

However, the disclosure is not limited thereto. In a display device 10D of another embodiment, a backlight module BLM-D may be provided without the configuration of the light guide plate 250 and the plurality of freeform surface lenses 255 in FIG. 14, as shown in FIG. 15.

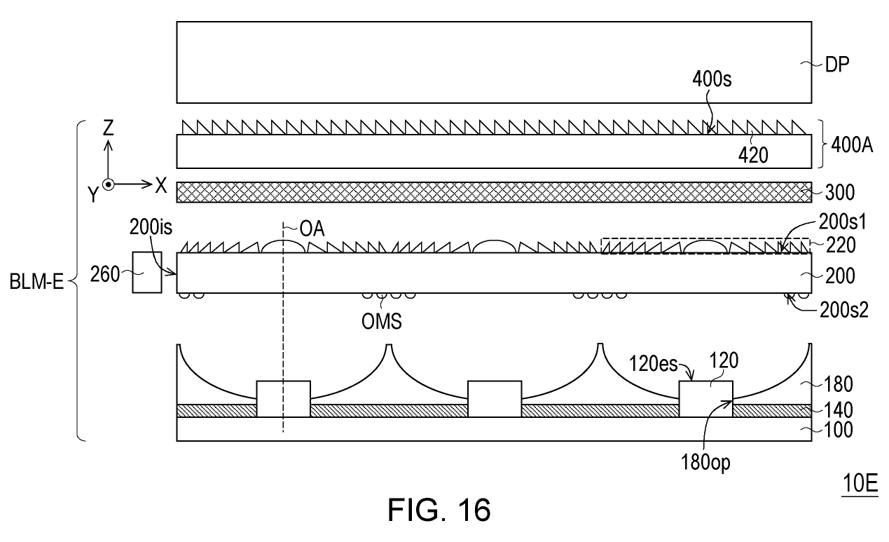

FIG. 16 is a schematic cross-sectional view of a display device according to a sixth embodiment of the disclosure. Referring to FIG. 16, compared with the display device 10D of FIG. 15, a backlight module BLM-E of a display device 10E of the embodiment may further include a reflective structure layer 180 to improve the light-emitting efficiency of the light-emitting elements 120. The reflective structure layer 180 is disposed between the plurality of Fresnel lenses 220 and the circuit board 100 and has a plurality of openings 180op. The plurality of light-emitting elements 120 are disposed in the openings 180op. In the embodiment, the reflective structure layer 180 is, for example, a reflective grating, but the disclosure is not limited thereto.

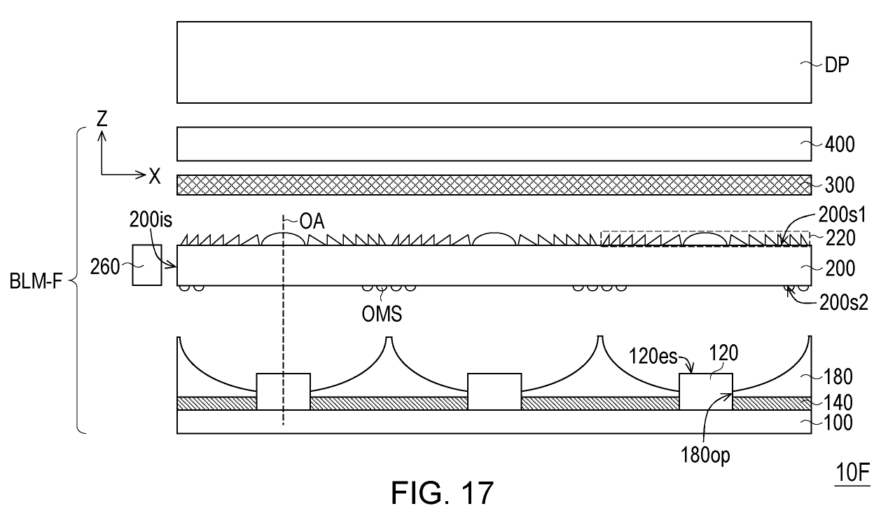

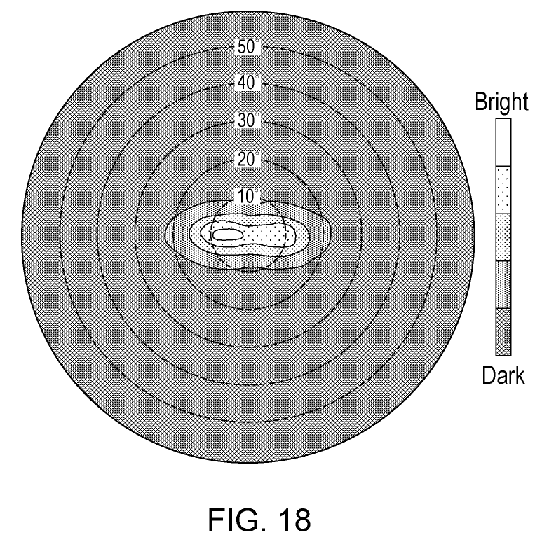

FIG. 17 is a schematic cross-sectional view of a display device according to a seventh embodiment of the disclosure. FIG. 18 is a diagram illustrating the light output distribution of the backlight module of FIG. 17. Referring to FIG. 17, in a display device 10F of the embodiment, the optical brightness enhancement film 400 of a backlight module BLM-F is not provided with the plurality of prism structures 420 shown in FIG. 16. As shown in FIGS. 7 and 18, compared with the backlight module BLM” of the comparative example, the backlight module BLM-F of the embodiment exhibits significantly better light-concentrating capability. In addition, the front-view luminance of the backlight module BLM-F of the embodiment can reach 2.2 times that of the backlight module BLM” of the comparative example.

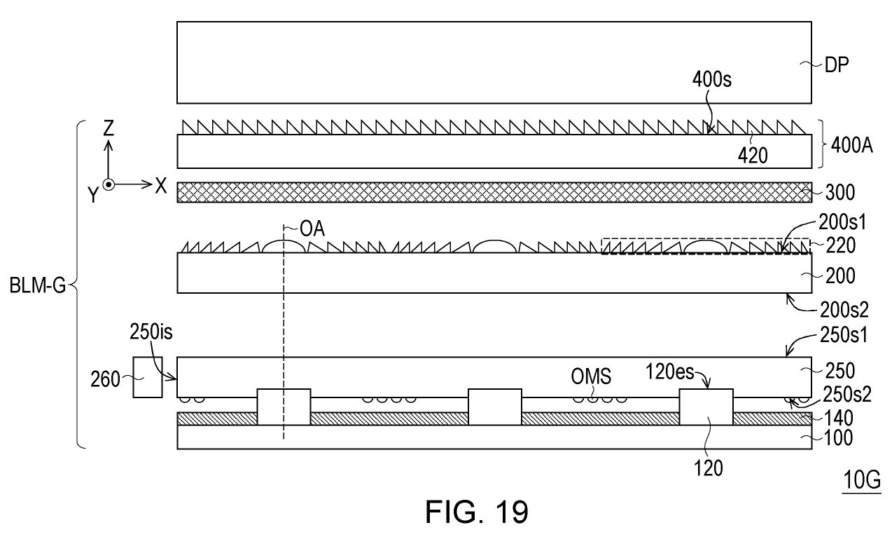

FIG. 19 is a schematic cross-sectional view of a display device according to an eighth embodiment of the disclosure. Referring to FIG. 19, in a display device 10G of the embodiment, a backlight module BLM-G is provided without the configuration of the plurality of freeform surface lenses 255 shown in FIG. 9. Since the remaining components of the backlight module BLM-G of the embodiment and the technical effects thereof are similar to those of the backlight module BLM-B shown in FIG. 9, detailed descriptions can be found in the related paragraphs of the aforementioned embodiment and will not be repeated here.

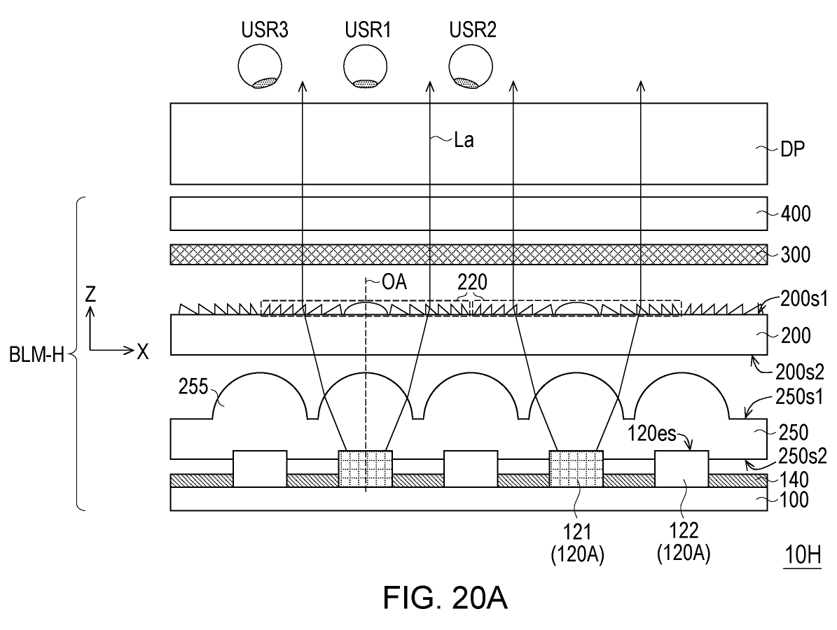

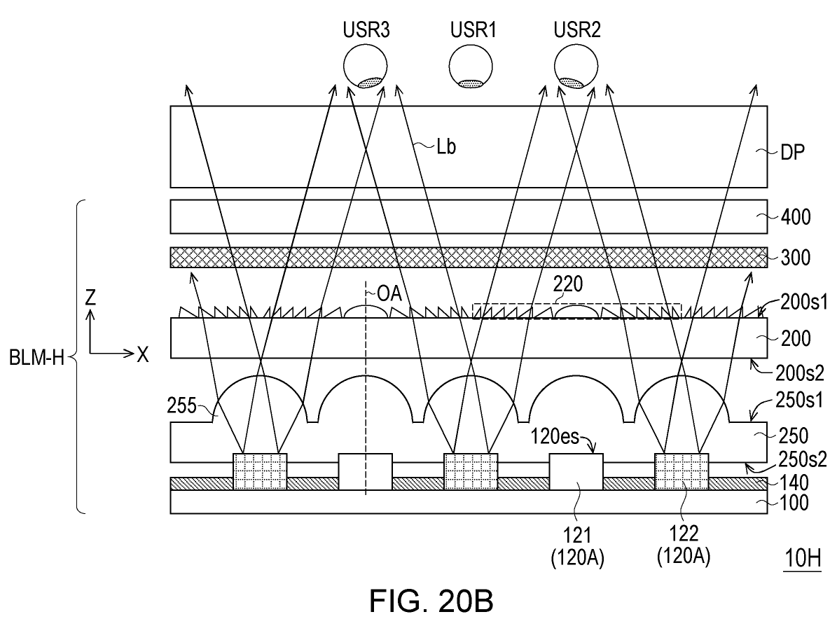

FIGS. 20A and 20B are schematic cross-sectional views of a display device according to a ninth embodiment of the disclosure, operated in a privacy mode and a sharing mode, respectively. Referring to FIGS. 20A and 20B, the main difference between a display device 10H of the embodiment and the display device 10A shown in FIG. 4 lies in the configuration of the light-emitting elements and the freeform surface lenses.

Specifically, in the embodiment, the plurality of light-emitting elements 120A in the backlight module BLM-H includes a plurality of first light-emitting elements 121 and a plurality of second light-emitting elements 122. The plurality of optical axes OA of the plurality of Fresnel lenses 220 respectively pass through the plurality of first light-emitting elements 121. Each of the plurality of second light-emitting elements 122 overlaps a connection portion between two adjacent ones of the plurality of Fresnel lenses 220 along a normal direction (e.g., direction Z) of the light-emitting surface 120es.

It is particularly noted that the light-emitting surface 120es of each of the plurality of first light-emitting elements 121 and the plurality of second light-emitting elements 122 is provided with a freeform surface lens 255. That is, in the embodiment, part of the freeform surface lenses 255 are not arranged on the plurality of optical axes OA of the plurality of Fresnel lenses 220.

When the plurality of first light-emitting elements 121 are enabled and the plurality of second light-emitting elements 122 are disabled, the light La emitted from each of the first light-emitting elements 121 and refracted by the freeform surface lens 255 and the Fresnel lens 220 has a narrower emission angle range when exiting the backlight module BLM-H, compared to the original emission angle range. At this time, a user USR1 viewing the display device 10H with a frontal viewing angle is located on the optical path of the light La emitted from the first light-emitting elements 121 and can view the display image on the display panel DP. However, users USR2 and USR3 viewing the display device 10H with oblique angles are located outside the optical path of the light La and cannot view the display image (as shown in FIG. 20A). That is, the display device 10H operates in the privacy mode.

When the plurality of first light-emitting elements 121 are disabled and the plurality of second light-emitting elements 122 are enabled (as shown in FIG. 20B), the light Lb emitted from each of the second light-emitting elements 122 and refracted by the freeform surface lens 255 and the Fresnel lens 220 exits the backlight module BLM-H at a large angle away from the normal direction of the light-emitting surface 120es. Therefore, the users USR2 and USR3 viewing the display device 10H with oblique angles are located on the oblique optical path of the light Lb emitted from the second light-emitting elements 122 and can view the display image on the display panel DP. However, the user USR1 viewing the display device 10H with a frontal viewing angle is located outside the oblique optical path of the light Lb and cannot view the display image. That is, the display device 10H operates in the sharing mode.

In other words, by switching the on/off states of the first light-emitting elements 121 and the second light-emitting elements 122, the operating mode of the display device 10H can be switched between the privacy mode and the sharing mode. On the other hand, the backlight module BLM-H of the embodiment is not provided with the auxiliary light-emitting element 260 and the plurality of optical microstructures OMS as shown in FIG. 4. However, the disclosure is not limited to the aforementioned sharing mode. In another sharing mode, the plurality of first light-emitting elements 121 and the plurality of second light-emitting elements 122 may be simultaneously enabled. At this time, the front-view user USR1 and the oblique-view users USR2 and USR3 can all view the display image on the display panel DP.

To sum up, in a backlight module and a display device according to an embodiment of the disclosure, a plurality of Fresnel lenses, an anisotropic diffusion sheet, and an optical brightness enhancement film are sequentially provided on a plurality of light-emitting surfaces of the plurality of light-emitting elements disposed on the circuit board. The light diffusion capability of the anisotropic diffusion sheet can enhance the quality of the backlight module, and its variation in light diffusion capability in different directions can satisfy different light distribution pattern requirements, thereby improving the light energy utilization efficiency of the backlight module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a circuit board;
a plurality of light-emitting elements, disposed on the circuit board;
an anisotropic diffusion sheet, disposed on one side of a light-emitting surface of each of the plurality of light-emitting elements;
a plurality of Fresnel lenses, disposed between the plurality of light-emitting elements and the anisotropic diffusion sheet, and arranged to overlap the plurality of light-emitting elements; and
an optical brightness enhancement film, disposed on one side of the anisotropic diffusion sheet facing away from the plurality of Fresnel lenses.

2. The backlight module according to claim 1, wherein each of the plurality of Fresnel lenses has an optical axis, and a plurality of optical axes of the plurality of Fresnel lenses respectively pass through the plurality of light-emitting elements.

3. The backlight module according to claim 1, further comprising:
a light guide plate, disposed between the plurality of light-emitting elements and the plurality of Fresnel lenses, and covering a plurality of light-emitting surfaces of the plurality of light-emitting elements; and
a plurality of freeform surface lenses, disposed on a first surface of the light guide plate facing away from the circuit board, and respectively overlapping the plurality of light-emitting elements.

4. The backlight module according to claim 3, further comprising:
an auxiliary light-emitting element, disposed on one side of a light-incident surface of the light guide plate; and
a plurality of optical microstructures, disposed on a second surface of the light guide plate and located between the plurality of light-emitting elements, wherein the light-incident surface connects the first surface and the second surface, and the second surface faces the circuit board.

5. The backlight module according to claim 4, wherein the plurality of optical microstructures are arranged without overlapping the plurality of freeform surface lenses along a normal direction of the second surface.

6. The backlight module according to claim 3, wherein the plurality of light-emitting elements include a plurality of first light-emitting elements and a plurality of second light-emitting elements, each of the plurality of Fresnel lenses has an optical axis, a plurality of optical axes of the plurality of Fresnel lenses respectively pass through the plurality of first light-emitting elements, and each of the plurality of second light-emitting elements overlaps a connection portion between two adjacent ones of the plurality of Fresnel lenses along a normal direction of the light-emitting surface.

7. The backlight module according to claim 1, wherein a plurality of prism structures is provided on a film surface of the optical brightness enhancement film facing away from the plurality of light-emitting elements.

8. The backlight module according to claim 7, wherein each of the plurality of prism structures includes a first optical surface and a second optical surface connected to each other, a first base angle between the first optical surface and the film surface is greater than a second base angle between the second optical surface and the film surface, and a plurality of first optical surfaces and a plurality of second optical surfaces of the plurality of prism structures are alternately arranged along a direction parallel to the film surface.

9. The backlight module according to claim 1, further comprising:
a light guide plate, disposed between the plurality of light-emitting elements and the anisotropic diffusion sheet, wherein the light guide plate has a light-incident surface and a first surface and a second surface connected to the light-incident surface and face away from each other;
an auxiliary light-emitting element, disposed on one side of the light-incident surface of the light guide plate; and
a plurality of optical microstructures, disposed on the second surface of the light guide plate and located between the plurality of light-emitting elements, wherein the plurality of Fresnel lenses are disposed on the first surface of the light guide plate.

10. The backlight module according to claim 9, wherein each of the plurality of Fresnel lenses has an optical axis, and a plurality of optical axes of the plurality of Fresnel lenses do not pass through the plurality of optical microstructures.

11. The backlight module according to claim 1, further comprising:
a reflective structure layer, disposed between the plurality of Fresnel lenses and the circuit board, and having a plurality of openings, wherein the plurality of light-emitting elements are disposed in the plurality of openings.

12. The backlight module according to claim 1, further comprising:
a light guide plate, disposed between the plurality of light-emitting elements and the plurality of Fresnel lenses, and covering a plurality of light-emitting surfaces of the plurality of light-emitting elements;
an auxiliary light-emitting element, disposed on one side of a light-incident surface of the light guide plate; and
a plurality of optical microstructures, disposed on a second surface of the light guide plate and located between the plurality of light-emitting elements, wherein the second surface connects the light-incident surface and faces the circuit board.

13. The backlight module according to claim 1, wherein the optical brightness enhancement film is a reflective polarizing brightness enhancement film.

14. The backlight module according to claim 1, further comprising:
a reflective sheet, disposed on the circuit board and exposing the plurality of light-emitting elements.

15. A display device, comprising:
a backlight module, comprising:
a circuit board;
a plurality of light-emitting elements, disposed on the circuit board;
an anisotropic diffusion sheet, disposed on one side of a light-emitting surface of each of the plurality of light-emitting elements;
a plurality of Fresnel lenses, disposed between the plurality of light-emitting elements and the anisotropic diffusion sheet, and arranged to overlap the plurality of light-emitting elements; and
an optical brightness enhancement film, disposed on one side of the anisotropic diffusion sheet facing away from the plurality of Fresnel lenses; and
a display panel, disposed on one side of the optical brightness enhancement film facing away from the plurality of light-emitting elements.

16. The display device according to claim 15, wherein the backlight module further comprises:
a light guide plate, disposed between the plurality of light-emitting elements and the plurality of Fresnel lenses, and covering a plurality of light-emitting surfaces of the plurality of light-emitting elements; and
a plurality of freeform surface lenses, disposed on a first surface of the light guide plate facing away from the circuit board, and respectively overlapping the plurality of light-emitting elements.

17. The display device according to claim 16, wherein the plurality of light-emitting elements includes a plurality of first light-emitting elements and a plurality of second light-emitting elements, each of the plurality of Fresnel lenses has an optical axis, a plurality of optical axes of the plurality of Fresnel lenses respectively pass through the plurality of first light-emitting elements, and each of the plurality of second light-emitting elements overlaps a connection portion between two adjacent ones of the plurality of Fresnel lenses along a normal direction of the first surface.

18. The display device according to claim 17, wherein when the plurality of first light-emitting elements are enabled and the plurality of second light-emitting elements are disabled, the display device operates in a privacy mode, and when the plurality of first light-emitting elements are disabled and the plurality of second light-emitting elements are enabled, the display device operates in a sharing mode.
